(19) United States
(12) Patent Application Publication
(10) Pub. No.: US 2020/0005354 A1
(43) Pub. Date: Jan. 2, 2020

(54) MACHINE LEARNING TECHNIQUES FOR MULTI-OBJECTIVE CONTENT ITEM SELECTION

(71) Applicant: Microsoft Technology Licensing, LLC, Redmond, WA (US)

(72) Inventors: Rupesh Gupta, Newark, CA (US); Guangde Chen, Milpitas, CA (US); Curtis Chung-Yen Wang, Mountain View, CA (US); Deepak K. Agarwal, Saratoga, CA (US); Souvik Ghosh, Saratoga, CA (US); Shipeng Yu, Sunnyvale, CA (US)

(21) Appl. No.: 16/024,753

(22) Filed: Jun. 30, 2018

(51) Int. Cl. G06Q 30/02; G06Q 10/06; G06N 99/00

(52) U.S. Cl. CPC G06Q 30/0243; G06N 99/005; G06Q 10/06315

(57) ABSTRACT

Machine learning techniques for multi-objective content item selection are provided. In one technique, resource allocation data is stored that indicates, for each campaign of multiple campaigns, a resource allocation amount that is assigned by a central authority. In response to receiving the content request, a subset of the campaigns is identified based on targeting criteria. Multiple scores are generated, each score reflecting a likelihood that a content item of the corresponding campaign will be selected. Based on the scores, a particular campaign from the subset is selected and the corresponding content item transmitted over a computer network to be displayed on a computing device. A resource allocation amount that is associated with the particular campaign is identified. A resource reduction amount associated with displaying the content item of the particular campaign is determined. The particular resource allocation is reduced based on the resource reduction amount.

### TECHNICAL FIELD

The present disclosure relates generally to computer network transmission of electronic content items and, more particularly to, applying machine learning techniques when considering multiple objectives in content item selection.

### BACKGROUND

Many web platforms provide multiple online services, such as an online network service, a messaging service, a publishing service, and a content distribution service, to name but a few. In order to inform users of these services, a web platform might provide information about each service to each visitor in addition to content requested by the visitor. However, providing such additional information might interfere with visitors' experiences. Also, knowing which additional information to provide is a difficult challenge due to various factors, such as the limited screen size of user devices, limited interest that users have in various content, and limited resources to present that content. Thus, decisions on what additional content to display and what not to display need to be made continuously. Some display strategies are more optimal than others.

One approach for displaying additional content involves allowing providers (or creators) of the additional content to decide when, where, and to whom to show their respective content. However, disadvantages of this approach include a high cost of serving the additional content (such as in the form of lost online engagement with electronic content that, for example, would be displayed instead of the additional content) and suboptimal returns.

Another approach for displaying additional content involves displaying a particular set of content items in a round robin fashion. Thus, each content item gets an equal chance of being displayed to end users. However, such an approach ignores the relative importance of each content item and how displaying each content item might negatively affect online engagement with the web platform.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts a system for distributing content items to one or more end-users, in an embodiment;

FIG. 2A is a block diagram that depicts an example online serving system for serving content items of campaigns, in an embodiment;

FIG. 2B is a block diagram that depicts an example online and offline serving system for serving content items and generating models, in an embodiment;

FIG. 3 is a block diagram that depicts an example training flow that depicts this training process, in an embodiment;

FIG. 4 is a flow diagram that depicts a process for selecting a campaign from among multiple eligible campaigns, in an embodiment;

FIG. 5 is a flow diagram that depicts a process for selecting a campaign according to the per-campaign value-based approach, in an embodiment;

FIG. 6 is a flow diagram that depicts a process for selecting a campaign according to the global constrained optimization approach, in an embodiment;

FIG. 7 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

A system and method are provided for identifying and distributing, over a computer network, electronic content pertaining to different online services and originating from different in-house creators. In one approach, a central authority allocates a certain amount of resources to each of multiple content delivery campaigns. In response to a content request, a machine-learned prediction model calculates a probability of user selection for each eligible content delivery campaign. For the selected campaign, a resource reduction amount is deducted from the allocated resources of the selected campaign. In another approach, a campaign-specific value is assigned to each campaign. Also, a multi-objective optimization technique is used to learn weights for a value objective and a cost objective. In response to a content request, a score is generated for each eligible campaign based on a machine-learned prediction model, a campaign value, a cost of each eligible campaign, and the learned weights. The campaign with the highest score is selected. In another approach, a multi-objective optimization technique is used to learn weights for each campaign objective and a cost tolerance. In response to a content request, a score is generated for each eligible campaign based on the campaign objectives of the eligible campaigns, a cost of each eligible campaign, and at least some of the learned weights. The campaign with the highest score is selected.

Thus, embodiments described herein improve computer processes in identifying relevant information through the use of specific rules to avoid the high cost of past approaches. These embodiments improve an existing technological process for identifying relevant information rather than merely using a computer as a tool to perform an existing process. Embodiments define specific ways to select relevant information, such as using machine-learning techniques to learn weights for particular objectives based on historical online activity. Embodiments prevent a significant sacrifice in online engagement with electronic engagement when determining which campaign to select in response to a content request.

### System Overview

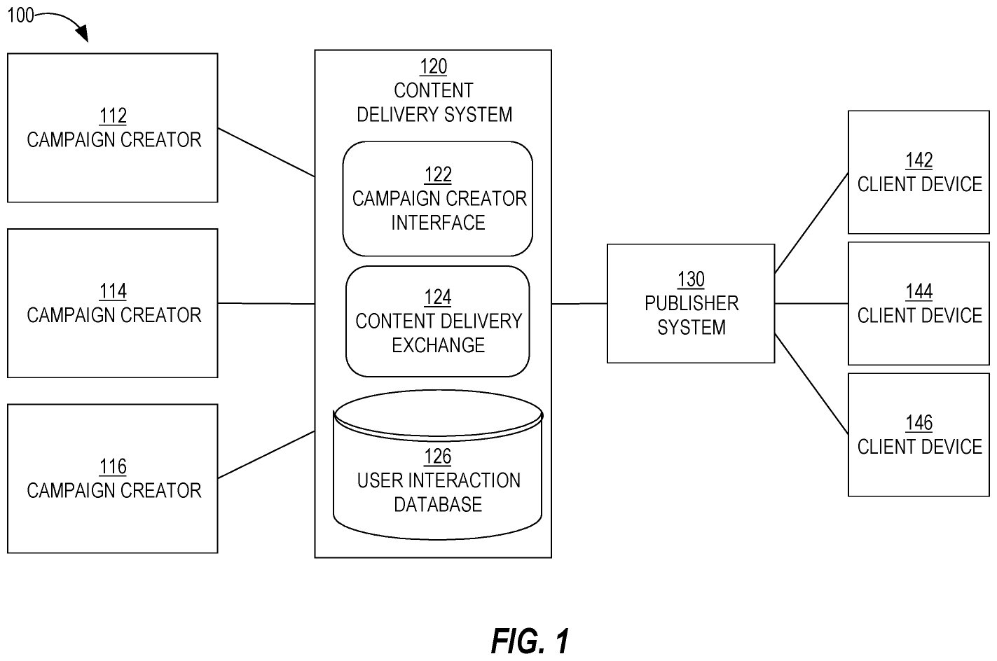

FIG. 1 is a block diagram that depicts a system 100 for distributing content items to one or more end-users, in an embodiment. System 100 includes campaign creators 112-116, a content delivery system 120, a publisher system 130, and client devices 142-146. Although three campaign creators are depicted, system 100 may include more or less campaign creators. Similarly, system 100 may include more than one publisher and more or less client devices.

Campaign creators 112-116 interact with content delivery system 120 (e.g., over a network, such as a LAN, WAN, or the Internet) to enable content items to be presented, through publisher system 130, to end-users operating client devices 142-146. Thus, campaign creators 112-116 provide content items to content delivery system 120, which in turn selects content items to provide to publisher system 130 for presentation to users of client devices 142-146. However, at the time that campaign creator 112 interacts with content delivery system 120, neither party may know which end-users or client devices will receive content items from campaign creator 112.

Although depicted in a single element, content delivery system 120 may comprise multiple computing elements and devices, connected in a local network or distributed regionally or globally across many networks, such as the Internet. Thus, content delivery system 120 may comprise multiple computing elements, including file servers and database systems. For example, content delivery system 120 includes (1) a campaign creator interface 122 that allows campaign creators 112-116 to create and manage their respective content delivery campaigns and (2) a content delivery exchange 124 that conducts content item selection events in response to content requests from a third-party content delivery exchange and/or from publisher systems, such as publisher system 130.

Publisher system 130 provides its own content to client devices 142-146 in response to requests initiated by users of client devices 142-146. The content may be about any topic, such as news, sports, finance, and traveling. Publishers may vary greatly in size and influence, such as Fortune 500 companies, online social network providers, and individual bloggers. A content request from a client device may be in the form of a HTTP request that includes a Uniform Resource Locator (URL) and may be issued from a web browser or a software application that is configured to only communicate with publisher system 130 (and/or its affiliates). A content request may be a request that is immediately preceded by user input (e.g., selecting a hyperlink on web page) or may initiated as part of a subscription, such as through a Rich Site Summary (RSS) feed. In response to a request for content from a client device, publisher system 130 provides the requested content (e.g., a web page) to the client device.

Simultaneously or immediately before or after the requested content is sent to a client device, a content request is sent to content delivery system 120 (or, more specifically, to content delivery exchange 124). That request is sent (over a network, such as a LAN, WAN, or the Internet) by publisher system 130 or by the client device that requested the original content from publisher system 130. For example, a web page that the client device renders includes one or more calls (or HTTP requests) to content delivery exchange 124 for one or more content items. In response, content delivery exchange 124 provides (over a network, such as a LAN, WAN, or the Internet) one or more particular content items to the client device directly or through publisher system 130. In this way, the one or more particular content items may be presented (e.g., displayed) concurrently with the content requested by the client device from publisher 130.

In response to receiving a content request, content delivery exchange 124 initiates a content item selection event that involves selecting one or more content items (from among multiple content items) to present to the client device that initiated the content request. An example of a content item selection event is an auction.

Content delivery system 120 and publisher system 130 may be owned and operated by the same entity or party. Alternatively, content delivery system 120 and publisher system 130 are owned and operated by different entities or parties.

A content item may comprise an image, a video, audio, text, graphics, virtual reality, or any combination thereof. A content item may also include a link (or URL) such that, when a user selects (e.g., with a finger on a touchscreen or with a cursor of a mouse device) the content item, a (e.g., HTTP) request is sent over a network (e.g., the Internet) to a destination indicated by the link. In response, content of a web page corresponding to the link may be displayed on the user's client device.

Examples of client devices 142-146 include desktop computers, laptop computers, tablet computers, wearable devices, video game consoles, and smartphones.

### Content Delivery Campaigns

Each campaign creator establishes a content delivery campaign with content delivery system 120 through, for example, campaign creator interface 122. Campaign creator interface 122 comprises a set of user interfaces that allow a campaign creator (or an authorized representative thereof) to create one or more content delivery campaigns and establish one or more attributes of each content delivery campaign. Examples of campaign attributes are described in detail below.

A content delivery campaign includes (or is associated with) one or more content items. Thus, the same content item may be presented to users of client devices 142-146. Alternatively, a content delivery campaign may be designed such that the same user is (or different users are) presented different content items from the same campaign. For example, the content items of a content delivery campaign may have a specific order, such that one content item is not presented to a user before another content item is presented to that user.

A content delivery campaign is an organized way to present information to users that qualify for the campaign. Different campaign creators have different purposes in establishing a content delivery campaign. Example purposes include having users view a particular video or web page, fill out a form with personal information, purchase a product or service, make a donation to a charitable organization, volunteer time at an organization, or become aware of an enterprise or initiative, whether commercial, charitable, social or political.

A content delivery campaign has a start date/time and, optionally, a defined end date/time. For example, a content delivery campaign may be to present a set of content items from Jun. 1, 2018 to Aug. 1, 2018, regardless of the number of times the set of content items are presented (“impressions”), the number of user selections of the content items (e.g., clicks), or the number of conversions that resulted from the content delivery campaign. Thus, in this example, there is a definite (or “hard”) end date. As another example, a content delivery campaign may have a “soft” end date, where the content delivery campaign ends when the corresponding set of content items are displayed a certain number of times, when a certain number of users view the set of content items or select or click on the set of content items, or when a certain number of users purchase a product/service associated with the content delivery campaign or fill out a particular form on a website.

A content delivery campaign may specify one or more targeting criteria that are used to determine whether to present a content item of the content delivery campaign to one or more users. Example factors include date of presentation, day of week of presentation, time of day of presentation, attributes of a user to which the content item will be presented, attributes of a computing device that will present the content item, identity of the publisher, etc. Examples of attributes of a user include demographic information, geographic information (e.g., of an employer), job title, employment status, academic degrees earned, academic institutions attended, former employers, current employer(s), number of connections in a social network, number and type of skills, number of endorsements, stated interests, number of invitations sent, number of invitations received, number of received invitations accepts, and invitation acceptance rate. Examples of attributes of a computing device include type of device (e.g., smartphone, tablet, desktop, laptop), geographical location, operating system type and version, size of screen, etc.

For example, targeting criteria of a particular content delivery campaign may indicate that a content item is to be presented to users with at least one undergraduate degree, who are unemployed, who are accessing from South America, and where the request for content items is initiated by a smartphone of the user. If content delivery exchange 124 receives, from a computing device, a request that does not satisfy the targeting criteria, then content delivery exchange 124 ensures that any content items associated with the particular content delivery campaign are not sent to the computing device.

Thus, content delivery exchange 124 is responsible for selecting a content delivery campaign in response to a request from a remote computing device by comparing (1) targeting data associated with the computing device and/or a user of the computing device with (2) targeting criteria of one or more content delivery campaigns. Multiple content delivery campaigns may be identified in response to the request as being relevant to the user of the computing device. Content delivery exchange 124 may select a strict subset of the identified content delivery campaigns from which content items will be identified and presented to the user of the computing device.

Instead of one set of targeting criteria, a single content delivery campaign may be associated with multiple sets of targeting criteria. For example, one set of targeting criteria may be used during one period of time of the content delivery campaign and another set of targeting criteria may be used during another period of time of the campaign. As another example, a content delivery campaign may be associated with multiple content items, one of which may be associated with one set of targeting criteria and another one of which is associated with a different set of targeting criteria. Thus, while one content request from publisher system 130 may not satisfy targeting criteria of one content item of a campaign, the same content request may satisfy targeting criteria of another content item of the campaign.

### Content Item Selection Events

As mentioned previously, a content item selection event is when multiple content items (e.g., from different content delivery campaigns) are considered and a subset selected for presentation on a computing device in response to a request. Thus, each content request that content delivery exchange 124 receives triggers a content item selection event.

For example, in response to receiving a content request, content delivery exchange 124 analyzes multiple content delivery campaigns to determine whether attributes associated with the content request (e.g., attributes of a user that initiated the content request, attributes of a computing device operated by the user, current date/time) satisfy targeting criteria associated with each of the analyzed content delivery campaigns. If so, the content delivery campaign is considered a candidate content delivery campaign. One or more filtering criteria may be applied to a set of candidate content delivery campaigns to reduce the total number of candidates.

As another example, users are assigned to content delivery campaigns (or specific content items within campaigns) “off-line”; that is, before content delivery exchange 124 receives a content request that is initiated by the user. For example, when a content delivery campaign is created based on input from a campaign creator, one or more computing components may compare the targeting criteria of the content delivery campaign with attributes of many users to determine which users are to be targeted by the content delivery campaign. If a user's attributes satisfy the targeting criteria of the content delivery campaign, then the user is assigned to a target audience of the content delivery campaign. Thus, an association between the user and the content delivery campaign is made. Later, when a content request that is initiated by the user is received, all the content delivery campaigns that are associated with the user may be quickly identified, in order to avoid real-time (or on-the-fly) processing of the targeting criteria. Some of the identified campaigns may be further filtered based on, for example, the campaign being deactivated or terminated, the device that the user is operating being of a different type (e.g., desktop) than the type of device targeted by the campaign (e.g., mobile device).

In one embodiment, content delivery exchange 124 conducts one or more content item selection events. Thus, content delivery exchange 124 has access to all data associated with making a decision of which content item(s) to select, including an identity of an end-user to which the selected content item(s) will be presented, an indication of whether a content item from each campaign was presented to the end-user, and a predicted CTR of each campaign.

### Tracking User Interactions

Content delivery system 120 tracks one or more types of user interactions across client devices 142-146 (and other client devices not depicted). For example, content delivery system 120 determines whether a content item that content delivery exchange 124 delivers is presented at (e.g., displayed by or played back at) a client device. Such a “user interaction” is referred to as an “impression.” As another example, content delivery system 120 determines whether a content item that exchange 124 delivers is selected by a user of a client device. Such a “user interaction” is referred to as a “click.” Content delivery system 120 stores such data as user interaction data, such as an impression data set and/or a click data set. Thus, content delivery system 120 may include a user interaction database 126.

For example, content delivery system 120 receives impression data items, each of which is associated with a different instance of an impression and a particular content delivery campaign. An impression data item may indicate a particular content delivery campaign, a specific content item, a date of the impression, a time of the impression, a particular publisher or source (e.g., onsite v. offsite), a particular client device that displayed the specific content item, and/or a user identifier of a user that operates the particular client device. Thus, if content delivery system 120 manages multiple content delivery campaigns, then different impression data items may be associated with different content delivery campaigns. One or more of these individual data items may be encrypted to protect privacy of the end-user.

Similarly, a click data item may indicate a particular content delivery campaign, a specific content item, a date of the user selection, a time of the user selection, a particular publisher or source (e.g., onsite v. offsite), a particular client device that displayed the specific content item, and/or a user identifier of a user that operates the particular client device. If impression data items are generated and processed properly, a click data item should be associated with an impression data item that corresponds to the click data item.

### Types of Campaigns

Different campaigns have different aims or objectives. Some campaigns may aim for users to edit their respective profiles while other campaigns may aim for users to install a particular application (e.g., a job seeker application provided through LinkedIn). Still other campaigns aim for users to submit request for proposals (e.g., using ProFinder™) while an objective for other campaigns is feed contributions, which is where users (e.g., registered members of an online social network) contribute custom content to publisher system 130 to be presented in feeds of other users, such as friends or connections of the content-contributing users.

An example of a content item is a promotion. A promotion is different than an advertisement. An advertisement campaign involves an advertiser paying money to a content distribution service that displays advertisements on behalf of the advertiser. In that scenario, the content distribution service makes money and the advertiser judges success of its campaign based on return on investment (ROI). In contrast, in a promotion campaign, no money is exchanged. Thus, promotion campaign creators pay no money and the content distribution service makes no money. Instead, presenting promotions represent a cost to the content distribution service. Cost may be in the form of loss of engagement and/or loss of revenue, which may be due to users not clicking on (or not being presented with) content items (e.g., advertisements) from advertisers.

Thus, in an embodiment, content delivery system 120 may manage both promotion campaigns and advertisement campaigns. In that case, not only might showing promotions cause users/visitors to not select (e.g., click on) non-marketing (e.g., organic) content presented through publisher system 130, showing promotions might also cause users to not select advertisements.

A promotion may be presented in one of multiple different ways on top of a page. Promotions may be limited to being displayed only on top of a page and not replacing any other content items (e.g., including advertisements) on the page. Example ways in which a promotion may be presented include a hover card (an informational pop-up on a page, activated when a user mouses over the card), a toast (a transient, information pop-up window), and a splash screen. A splash screen is a graphical control element comprising a window containing an image, a logo, and, optionally, a current version of software. Splash screens are typically used by particularly large applications to notify the user that the program is in the process of loading. Splash screens may provide feedback that a lengthy process is underway. A progress bar within the splash screen may indicate the loading progress. A splash screen may disappear when the application's main window appears. Splash screens serve to enhance the look and feel of an application or web site. A splash screen may also contain animations, graphics, and sound.

### Per-Campaign Resource Limit Approach

In an embodiment, a central authority establishes a global resource limit for all (or multiple) campaigns. The central authority may be a single person or a group of people, such as a committee. A global resource limit may be established explicitly or may be implicit based on an explicit resource limit for each campaign. The value for a resource limit may vary depending on what is being tracked. For example, the resource may reflect a cost of presenting content items from the respective campaigns. In this example, the cost may be how much revenue is lost due to presenting content items from one or more campaigns. As another example, the resource may reflect a loss of user engagement in a particular web page or in a particular application. In this example, the user engagement may be determined based on a time spent on a particular web page or in a particular application, a number of clicks on links of the displayed content, a number of scrolls within displayed content, etc.

As another example, a central authority indicates that promotions are not to cost more than 100,000 lost clicks and $10,000 lost revenue from the page (or pages) on which promotions are going to be displayed. This budget is distributed to all the promotion campaigns by the central authority. Thus, each promotion campaign has its own budget. Each time a promotion is shown, the actual cost of showing that promotion is deducted from the corresponding campaign's resource allocation. The promotion serving platform maximizes the total number of clicks on all promos while ensuring that each promo is displayed only as many times as its resource allocation allows.

In a related embodiment, the central authority specifies a global resource limit (e.g., certain revenue loss, particular decrease in user engagement) and a percentage to each campaign. For example, campaign A is assigned 80% while campaign B is assigned 20%, indicating that campaign A is more important than campaign B.

In a related embodiment, each page type (or content type) may be associated with a different resource limit. For example, user profile pages may have one global resource limit, company profile pages may have another global resource limit, job posting pages may have another global resource limit, and search pages may have another global resource limit.

### Example Campaign Selection Process

In response to receiving a content request initiated by a particular user, content delivery exchange 124 selects a set of candidate promotion campaigns based on the targeting criteria of each candidate promotion campaign and promotion campaigns that have remaining resources. Thus, if a promotion campaign has exhausted its resources, then the promotion campaign is not selected as a candidate promotion campaign. Also, if attributes of the content request (which may include attributes of the particular user) does not satisfy the targeting criteria of a promotion campaign, then the promotion campaign is not selected as a candidate promotion campaign.

A score is computed for each candidate promotion campaign. A score represents a likelihood or probability that a content item of the corresponding campaign will be selected by the particular user. The candidate promotion campaign that is associated with the highest score is selected.

### Reducing Resource Allocations

In an embodiment, each time a content item from a campaign is selected for presentation to an end user, the associated resource allocation of that campaign is reduced. The amount of reduction may vary from campaign to campaign or may be the same. For example, some campaigns may have a higher reduction amount than the reduction amounts of other campaigns. Such a difference may reflect that some campaigns “cost” more than other campaigns. Thus, if (1) a first campaign has more resource allocation than a second campaign and (2) the cost of impression of each campaign is roughly the same, then the first campaign will have more impressions than the second campaign.

Additionally or alternatively to varying the reduction amount from campaign to campaign, the reduction amount may vary from page type (or content type) to page type. For example, content items that are presented on pages of type A will have a first reduction amount and content items that are presented on pages of type B will have a second reduction amount that is different than the first reduction amount. As a specific example, the cost of presenting a promotion of a job seeker application on a jobs-related page (e.g., a page of job postings) may be less than the cost of presenting a promotion of professional finder application on the jobs-related page.

In an embodiment, the cost of presenting a promotion on one page may be of a different type than the cost of presenting the promotion on another page. For example, some pages (or pages of a particular type) might not include any advertisements. Thus, there is no revenue loss for displaying a promotion. Instead, a different type of cost may be associated with those pages, such as loss of user engagement.

In an embodiment where a promotion is displayed within a page, a location of a page on which a promotion is displayed is a factor in a cost of the promotion. For example, a location that is higher up a page will be associated with a higher cost than a location that is lower in the page. As another example, a location earlier in a feed will be associated with a higher cost than a location later in a feed.

In an embodiment, a reduction amount is determined based on measurements. For example, a first measurement is made regarding a first number of clicks when no promotions are presented and a second measurement is made regarding a second number of clicks when some promotion is presented. For example, the first number of clicks may be 1000 and the second number of clicks may be 337. Thus, the cost of running a promotion is 663 (i.e., 1000-663). As another example, where the cost type is CTR instead of number of clicks, a first measurement is made regarding a first click-through rate (CTR) when no promotions are presented and a second measurement is made regarding a second CTR when some promotion is presented. For example, the first CTR may be 0.004 and the second CTR may be 0.001. Thus, the cost of each promotion is 0.003 (i.e., 0.004-0.001). Thus, each promotion has the same cost.

Alternatively, measurements are made on a per campaign basis, meaning that different campaigns have a different cost. For example, a first measurement is made regarding a first number of clicks when no promotions are presented, a second measurement is made regarding a second number of clicks when a first promotion campaign is presented, and a third measurement is made regarding a third number of clicks when a second promotion campaign is presented. For example, the first number of clicks may be 1000, the second number of clicks may be 337, and the third number of clicks may be 559. Thus, the cost of presenting the first promotion is 663 (i.e., 1000-337) and the cost of presenting the second promotion is 441 (i.e., 1000-559). As another example, where the cost type is click-through rate (CTR) instead of number of clicks, a first measurement is made regarding a first CTR when no promotions are presented, a second measurement is made regarding a second CTR when a first promotion campaign is presented, and a third measurement is made regarding a third CTR when a second promotion campaign is presented. For example, the first CTR may be 0.004, the second CTR may be 0.001, and the third CTR may be 0.002. Thus, the cost of presenting the first promotion is 0.003 (i.e., 0.004-0.001) and the cost of presenting the second promotion is 0.002 (i.e., 0.004-0.001).

In a related embodiment, a reduction amount is determined based on measurements on a per-page basis. For example, a first measurement is made regarding a first number of clicks on a particular type of page (e.g., a home page, a profile page, a company profile page, a job posting page, a people search page, a job search page) when no promotions are presented and a second measurement is made regarding a second CTR on the same type of page or similar page when some promotion is presented. For example, the first number of clicks may be 1000 and the second number of clicks may be 331. Thus, the cost of the promotion is 669 (i.e., 1000-331) with respect to that particular type of page. As another example, when the cost type is CTR instead of number of clicks, a first measurement is made regarding a first CTR on a particular type of page (e.g., a home page, a profile page, a company profile page, a job posting page, a people search page, a job search page) when no promotions are presented and a second measurement is made regarding a second CTR on the same type of page or similar page when some promotion is presented. For example, the first CTR may be 0.004 and the second CTR may be 0.001. Thus, the cost of each promotion is 0.003 (i.e., 0.004-0.001) with respect to that particular type of page.

In a related embodiment, a reduction amount is determined based on measurements on a per-campaign and per-page basis. For example, a first measurement is made regarding a first number of clicks on a particular type of page when no promotions are presented, a second measurement is made regarding a second number of clicks on the same type of page or similar page when a first promotion is presented, and a third measurement is made regarding a third number of clicks on the same type of page or similar page when a second promotion is presented. For example, the first number of clicks may be 1000, the second number of clicks may be 331, and the third number of clicks may be 572. Thus, the cost of the first promotion on the particular type of page is 669 (i.e., 1000-331) and the cost of the second promotion on the particular type of page is 428 (i.e., 1000-572). The number of clicks (and, therefore, the respective costs) of the first and second promotions may be different on a different type of page. As another example, when the cost type is CTR instead of number of clicks, a first measurement is made regarding a first CTR on a particular type of page when no promotions are presented, a second measurement is made regarding a second CTR on the same type of page or similar page when a first promotion is presented, and a third measurement is made regarding a third CTR on the same type of page or similar page when a second promotion is presented. For example, the first CTR may be 0.004, the second CTR may be 0.001, and the third CTR may be 0.002. Thus, the cost of the first promotion on the particular type of page is 0.003 (i.e., 0.004-0.001) and the cost of the second promotion on the particular type of page is 0.002 (i.e., 0.004-0.001). The CTR values (and therefore the respective costs) of the first and second promotions may be different on a different type of page.

### Machine-Learned Cost Model

In another embodiment, a reduction amount is estimated using a machine-learned model. The cost model may be defined as follows:

cost=E_{metric}(with campaign)−E_{metric}(without campaign)

where “cost” is a negative value if E_{metric}(without campaign) is greater than E_{metric}(with campaign), and where E_{metric} is a predicted metric that is based on a machine-learned model that is based on user features, campaign features, context features, and/or an intersection of member features and campaign features.

Example static user features include geography, academic institution attended, job industry, and language. Values for these user features may be retrieved from user profiles. Example dynamic user features include a number of times a user has seen any promotion campaign in the past X days, a number of times the user has seen any promotion campaign in the past day, a number of times the user has click on any promotion in the past X days, a number of times the user has clicked on any promotion in the past day, a number of times the user has dismissed any promotion campaign in the past X days, a number of times the user has dismissed any promotion campaign in the past day, a last visit time of the user, a last time a content item from a promotion campaign was presented to the user, an identity of the last promotion campaign whose content item was shown to the user, a number of job views in the last X days (which indicates job seeking intent), a number of job applies in the last X days (which also indicates job seeking intent), a number of invitations sent in the last X days (which indicates an intent to grow the user's network), a number of invites accepted in the last X days (which also indicates an intent to grow the user's network), a number of engaged feed sessions in the last X days (which indicates an intent to stay informed).

Example campaign features include team/type/pillar (e.g., talent solutions, marketing solutions, sales solutions), objective (e.g., revenue, app installs, brand affinity), title, Body/Tags (“Body” refers to text in the body of the campaign whereas “Tags” refers to keywords/topics from the body of the campaign), start date, and duration. Example context features include placement (e.g., device, page, and position) and other content on the page.

When computing E_{metric}(without campaign), the feature values for campaign features would be 0.

Each training instance to train the model for E_{metric} comprises a list of member/campaign/context features for a given impression with a label indicating the value derived. The label may be binary (e.g., indicating whether there was any feed engagement or whether the user clicked on a link on the page) or a real number (e.g., a number of clicks on the page). If the label is binary, then a logistic regression model may be used. If the label is a real number, then a linear regression model may be used.

### Short Lived Campaigns

As described herein, a central authority allocates resources to each campaign for a period of time, such as three months. After the period of time elapses, the central authority again allocates resources to each campaign. The number of campaigns during the second period of time may be the same as or different than the number of campaigns that were active during the first period of time. The re-allocation may be automatic by default or may be performed manually.

In some situations, a new campaign is active only during a subset of a period of time. For example, a new campaign becomes active towards the end of a period. As another example, the new campaign is one that wishes members of an online social network a happy new year, which might only run for a single day. A challenge is to give all the target number of impressions to this new campaign in a single day. This can be achieved by ensuring a uniform distribution of resource usage over the lifetime of the campaign. One technique is to monitor the total resource usage for the campaign every X hours (or other time unit) and flag the campaign as ineligible if the resource usage is more than the expected resource usage.

However, this technique does not work for poor performing campaigns as this technique does not provide a way to boost a campaign. A technique to increase the score of a campaign that has relatively little remaining life and a relatively large remaining resource allocation is to boost the score of the campaign with a multiplier, such as a value greater than 1. The following is a generic table that illustrates different values of a multiplier given different scenarios:

| Remaining Resource Allocation | Remaining Life | Score Multiplier |
|---|---|---|
| Small | Small | 1 |
| Large | Small | >1 |
| Small | Large | <1 |
| Large | Large | 1 |

### Campaigns without Call-to-Action

Some campaigns might not have a call-to-action (CTA). For example, a campaign that wishes members a happy new year are not likely to be clicked and, consequently, will have a very low probability of being selected (e.g., clicked). In an embodiment, to handle such campaigns, a fixed click probability is computed for these campaigns as an average (or median) probability of all promotion campaigns.

### Online Serving System

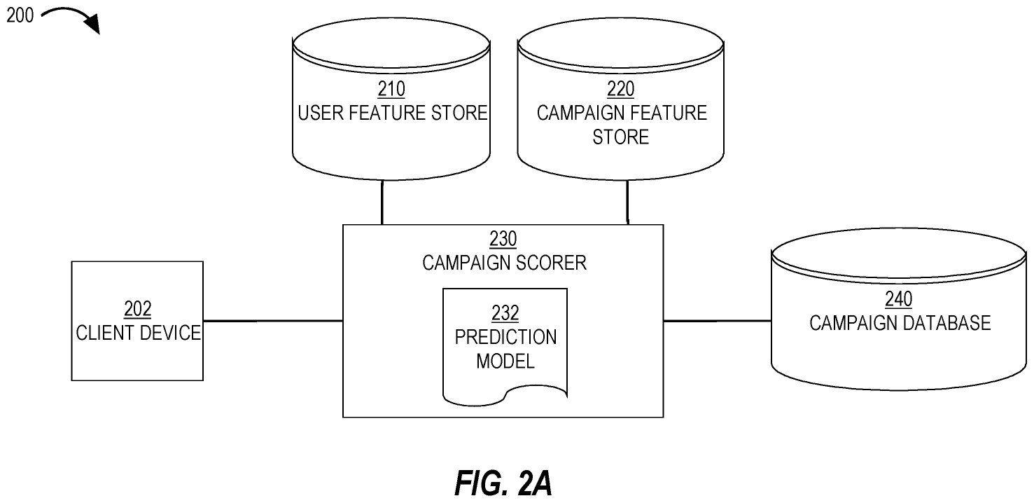

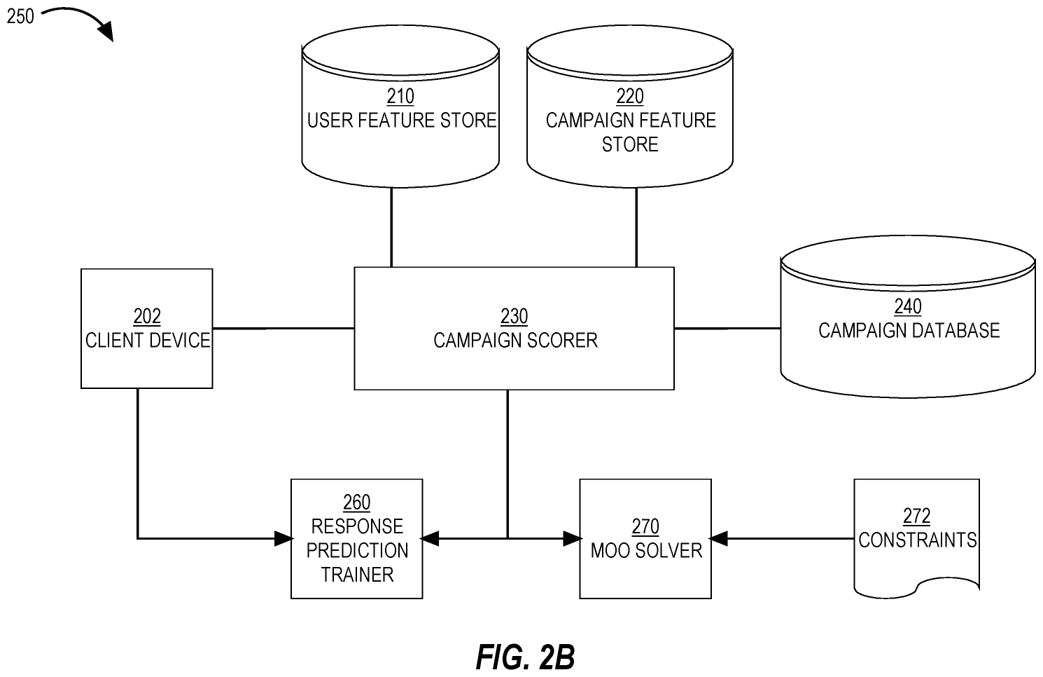

FIG. 2A is a block diagram that depicts an example online serving system 200 for serving content items of campaigns, in an embodiment. Online serving system 200 may be part of content delivery system 120 and/or publisher system 130. Online serving system 200 includes a user feature store 210, a campaign feature store 220, a campaign scorer 230, and a campaign database 240. While only a single client device 202 is depicted, multiple client devices may initiate communications with online serving system 200.

A user operating client device 202 requests a page on a mobile or web application. In doing so, client device 202 transmits a user identifier over a computer network (not depicted) to campaign scorer 230. Campaign scorer 230 sends the user identifier to campaign database 240, which stores information about active campaigns along with resource allocations and, optionally, one or more campaign features. Campaign database 240 is a combination of hardware, software, and storage and includes functionality to respond to requests from campaign scorer 230.

Campaign database 240 identifies eligible campaigns (e.g., that target the user identifier and have remaining resources) and returns data that identifies the eligible campaigns (and, optionally, one or more campaign features) to campaign scorer 230.

Campaign scorer 230 requests (e.g., based on a campaign identifier associated with each eligible campaign from campaign database 240) features of all eligible campaigns from campaign feature store 220. Campaign scorer 230 also requests, from user feature store 210, features of the user corresponding to the user identifier. This request may be initiated even before campaign scorer 230 transmits the user identifier to campaign database 240.

Campaign scorer 230 concatenates the user features (from user feature store 210) with each set of campaign features (from campaign feature store 220 and, optionally, campaign database 240) to generate a feature vector for each eligible campaign. Each feature vector comprises multiple feature values, each corresponding to a different feature. If there are five eligible campaigns, then campaign scorer 230 generates five feature vectors. The user feature portion of each feature vector will be the same.

Campaign scorer 230 applies each generated feature vector to a prediction model 232, which outputs a score based on the feature vector. Campaign scorer 230 selects the eligible campaign that is associated with the highest score. Campaign scorer 230 causes a content item of the selected campaign to be transmitted over the computer network to client device 202.

Campaign scorer 230 determines (e.g., calculates) a cost of presenting the content item to the user of client device 202. Campaign scorer 230 sends, to campaign database 240, that cost along with a campaign identifier that identifies the selected campaign so that campaign database 240 updates the resource allocation of the selected campaign based on the cost. For example, campaign database 240 reduces the resource allocation of the selected campaign by an amount indicated by the cost.

### Training Data Collection

Whether training a prediction model for the per-campaign resource limit approach or training a multi-objective optimization (MOO) model, training data is collected. For training a prediction model, the training data is randomized to eliminate any serving bias and adequately explore the feature space. Such randomization can be obtained by showing random content items from promotion campaigns to a (e.g., small) set of users. For training a MOO model, the set of all eligible promotions for each promotion impression opportunity is used. A random bucket serves as a representative sample of the entire space. Thus, eligible promotion campaigns are logged for each promo request in the random bucket.

FIG. 2B is a block diagram that depicts an example online and offline serving system 250 for serving content items and generating models, in an embodiment. While serving system 250 includes a response prediction trainer 260 and a MOO solver 270, other embodiments only include one or the other. If MOO solver 270 is included, then an input to MOO solver 270 is a set of constraints 272, such as maximizing clicks such that (1) the total cost of showing a content item of one campaign is less than or equal to a resource allocation of that campaign, (2) the total cost of showing a content item of another campaign is less than or equal to a resource allocation of that other campaign, and so forth for each campaign. A solution to this optimization problem indicates whether to show any campaign and what campaign to show in each page view. This is difficult to implement since this would require a forecast of all impression opportunities (page views).

Similar to the description above, a user operating client device 202 requests a page on a mobile or web application. All the elements depicted in FIG. 2A operate the same in FIG. 2B. However, campaign scorer 230 determines whether to select a random campaign from the set of eligible campaigns that are returned by campaign database 240. Such a determination may be based on calling a service (not depicted), which determines whether the user will be treated with a random selection. If not, then the process described above is followed. If the determination is that the treatment will be random, then not only will campaign scorer 230 select an eligible campaign randomly (or at least pseudo-randomly), campaign scorer 230 also stores (or logs) the eligible campaigns long with their respective features in offline storage (e.g., Hadoop storage).

Client device 202 also generates an impression event (if the content item of the selected campaign is displayed on a screen of client device 202) and a click event (if the user selects (or clicks) the content item). Client device 202 transmits any impression event and any click event to the offline portion of serving system 250, to be processed in order to train one or more models.

Another difference with FIG. 2A is that campaign score 230 also transmits, to the offline portion of serving system 250, the user and campaign features of a content item selection event or a user identifier to allow the offline system to look up the user features when generating the training data.

### Offline Model Training System

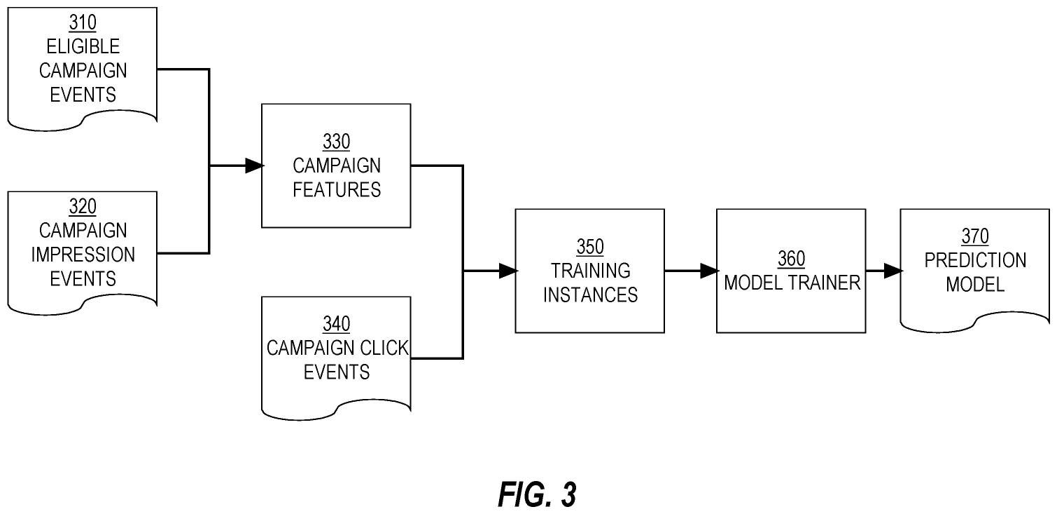

In order to train a click prediction model, training instances comprising feature values and a response (e.g., click or no click) are needed. Training instances may be generated based on data collected from the random bucket (described above) as follows: (1) all impression events are loaded and joined with eligible campaign events to obtain features for the impressed campaigns; (2) click events are loaded and joined with impression events to obtain the response (e.g., 0 for no click and 1 for click) for each impressed campaign; (3) train a model using the resulting training instances. FIG. 3 is a block diagram that depicts an example training flow that depicts this training process, in an embodiment. Eligible campaign events 310 (which include or are associated with campaign features) are joined with campaign impression events 320 to obtain campaign features 330 of each impression. Campaign features 330 are joined with campaign click events 340 to generate training instances 350, one training instance for each impression. A training instance includes the features of the corresponding campaign and a label indicating whether the content item corresponding to the impression was selected (or clicked) by a user. Training instances 350 are input to a model trainer 360 to train a prediction model 370. Model trainer 360 may use one or more machine learning techniques to train prediction model 370. Example machine learning techniques include logistic regression and XGBoost, which is an open-source software library that provides a gradient boosting framework for C++, Java, Python, R, and Julia.

### Features of Prediction Model

The features for prediction model 370 may be from one or more of the following six categories: static user features, dynamic user features, static campaign features, dynamic campaign features, dynamic (user X campaign) features, and context features. Values of static features change slowly (e.g., job title, past employer) while values of dynamic features might change in real-time. Some of features are useful for deciding which campaign to select while other features are useful for deciding whether to select a campaign at all. The user features capture whether the user wants to find a job (job applies) or grow her network (invites sent and accepted) or just stay informed (e.g., engaged feed sessions).

Example static user features include whether a user has been classified as an influencer (which may be determined based on online activity of the user) and profile features, such as geo, school, job industry, and language.

Example dynamic user features include a number of times a user has seen any promotion campaign in the past X days, a number of times the user has seen any promotion campaign in the past day, a number of times the user has dismissed any promotion campaign in the past X days, a number of times the user has dismissed any promotion campaign in the past day, a last visit time of the user, a last time a content item from a promotion campaign was presented to the user, an identity of the last promotion campaign whose content item was shown to the user, a number of job views in the last X days (which indicates job seeking intent), a number of job applies in the last X days (which also indicates job seeking intent), a number of invitations sent in the last X days (which indicates an intent to grow the user's network), a number of invites accepted in the last X days (which also indicates an intent to grow the user's network), a number of engaged feed sessions in the last X days (which indicates an intent to stay informed), a number of page views in the last X days, a number of endorsements that the user has, a number of connections that the user has, a number of promotion campaigns targeting the user, an identity of the last page visited by the user, an identity of the last action performed by the user, a number of user sessions by the user in the last X days, a number of page views by the user in the last X days.

Example static campaign features include type (e.g., talent solutions, marketing solutions, sales solutions), objective, title, Body/Tags (“Body” refers to text in the body of the campaign whereas “Tags” refers to keywords/topics from the body of the campaign), start date, duration, and language.

Example dynamic campaign features include a number of times the campaign has been shown to anyone in the past X days, a number of times the campaign has been shown to anyone in the past day, a number of times the campaign has been clicked by anyone in the past X days, a number of times the campaign has been clicked by anyone in the past day, a number of times the campaign has been dismissed by anyone in the past X days, and a number of times the campaign has been dismissed by anyone in the past day.

Example dynamic (member x campaign) features include a number of times the user has seen a content item from the campaign, a number of times the user has seen a content item from the campaign in the past X days, a number of times the user has clicked on a content item from the campaign, a number of times the user has selected (e.g., clicked) a content item from the campaign in the past X days, a number of times the user has dismissed a content item from the campaign, a number of times the user has dismissed a content item from the campaign in the past X days, a last time a content item from the campaign was presented to the user.

Example context features include placement (e.g., device (e.g., iOS, Android, Mobile Web, Desktop), page (e.g., feed page, notifications page, profile page, etc.), and style (e.g., hover card, toast, embedded)), day of week, and the current date. Contextual feature values may be passed by the client devices that generate the impression events and (optionally) the click events.

### Example Process for the Per-Campaign Resource Limit Approach

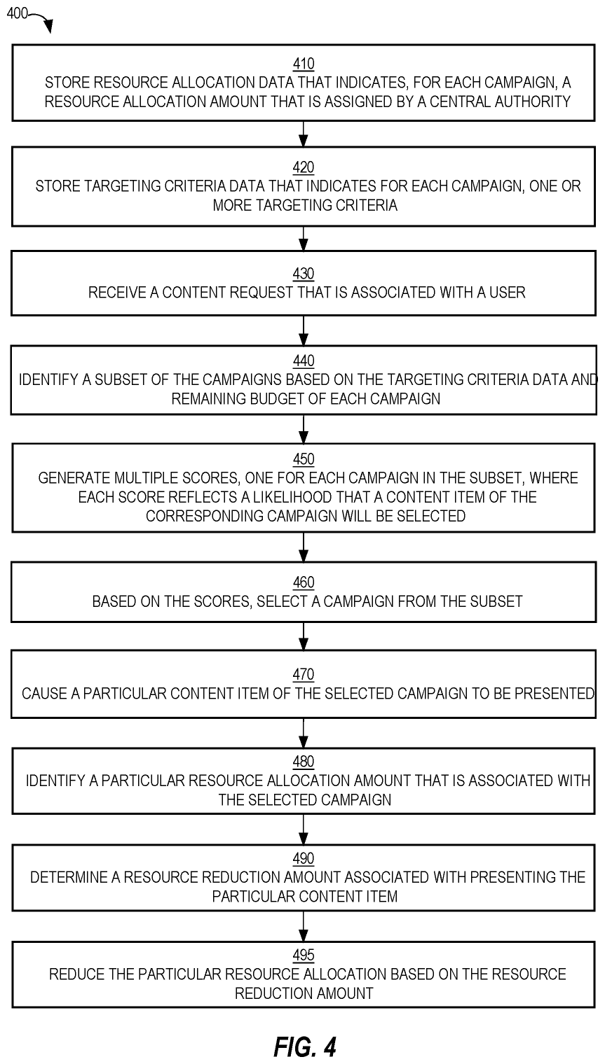

FIG. 4 is a flow diagram that depicts a process 400 for selecting a campaign from among multiple eligible campaigns, in an embodiment.

At block 410, resource allocation data is stored that indicates, for each campaign of multiple campaigns, a resource allocation amount that is assigned by a central authority.

At block 420, targeting criteria data is stored that indicates, for each campaign, one or more targeting criteria that is assigned by a different entity, each of which is different than the central authority. However, the different entities are all associated with content delivery system 120. For example, the different entities may be different teams that are employed by the party that owns and/or operates content delivery system 120. When a content request is received, each campaign may also be associated with user identifiers that have already been matched to the campaign.

At block 430, a content request is received. For example, publisher system 130 receives a content request from client device 144. As another example, content delivery system 120 receives a content request from client device 144 or from publisher system 130. If the latter, then the content request is triggered or initiated by a request from a client device, such as client device 144.

At block 440, a subset of the campaigns is identified based on the targeting criteria data.

At block 450, multiple scores for the campaigns in the subset are generated, where each score reflects a likelihood that a content item (or promotion) of the corresponding campaign will be selected.

At block 460, based on the scores, a particular campaign from the subset is selected.

At block 470, a particular content item of the particular campaign is caused to be presented. Block 470 may involve content delivery system 120 transmitting a message that includes the particular content item (or a reference to the particular content item) over a computer network to a client device, such as client device 144.

At block 480, a particular resource allocation amount that is associated with the particular campaign is identified. Block 480 may be determined from the resource allocation data stored in block 410.

At block 490, a resource reduction amount associated with presenting the particular content item of the particular campaign is determined. The resource reduction amount may be dependent on the page (or page type) through which the particular content item will be presented.

At block 495, the particular resource allocation is reduced based on the resource reduction amount. Block 495 may involve subtracting the resource reduction amount from the particular resource allocation amount.

Blocks 430-495 may repeat for each content request received.

An advantage to the per-campaign resource limit approach is that each campaign with a non-zero resource limit will get an opportunity to be presented to end users. Another advantage is that computing the global resource limit is relative easy. For example, a control bucket is run where no promotion is shown. This bucket is compared with a “random” bucket where random promotions are shown. The comparison indicates a loss in engagement and/or revenue on a page due to displaying random promotions. The global resource limit may be set as a fraction of this loss. Also, the global resource limit may be set for each page (or page type) of multiple pages (or page types).

A disadvantage of the per-campaign resource limit approach is that allocating resource limits to campaign creators is difficult because the objective of one campaign (e.g., brand affinity) can be very different than the objective of another campaign (e.g., application installs). Another disadvantage is that adding a new campaign is not trivial if the entire global resource limit has already been allocated.

### Per-Campaign Value-Based Approach

An alternative approach to the per-campaign resource limit approach is the per-campaign value-based approach. In this approach, each campaign is assigned a value that, when combined with a probability of selecting the corresponding content item, is used to determine which campaign of a set of candidate campaigns to select. Thus, instead of being allocated a certain resource amount, a campaign is assigned a value (or “campaign value”) that, in light of values assigned to other campaigns, represents a relative importance of the campaign. A campaign value is combined with a user selection prediction or probability to come up with a score.

In an embodiment, a campaign value is determined based on an expected revenue from a conversion associated with the corresponding campaign. For example, analyzing past online user behavior reveals that 10% of clicks result in conversions. Each past conversion is analyzed to determine (e.g., an average) revenue from each conversion. As noted previously, different campaigns have different objectives. For example, if the objective of one campaign is to install an application, then it is determined how much revenue has been generated from past installations of the application. Revenue from application installs may come from advertisements that are shown through the application and/or purchases that are made through the application. A median or average revenue per installation may be computed and subsequently used by multiplying that revenue value by the probability that a user selection (e.g., click) of a promotion results in an installation. The resulting value may be assigned to the app install campaign.

As another example, if the objective of a campaign is feed contribution, then a number (and/or type) of downstream engagements from previous feed contributions is determined. Each downstream engagement may be given the same value. Alternatively, different types of downstream engagements (e.g., views, clicks, shares, comments, likes) may be given different values. A probability that a single feed contribution will result in a downstream engagement may be calculated based on past online user activity. Alternatively, if each type of downstream engagement is tracked, then a probability is calculated (based on past online user activity) for each type of downstream engagement that a single feed contribution will result in that type of downstream engagement. Such probabilities may be combined to yield a single value for the feed contribution campaign.

A campaign value (which may also be referred to as a “bid”) may be established by a central authority in order to ensure fairness. Alternatively, a campaign value may be established by each campaign creator/owner. Alternatively still, some campaigns may be assigned a value by the central authority while other campaigns may be assigned a value by their respective campaign creators.

Content delivery system 120 maximizes the total value across multiple (e.g., all) promotion campaigns while ensuring that the total cost of showing the respective promotions does not exceed a predefined tolerance. The multi-objective optimization problem is written where the objective is to maximize value and the constraint is cost <tolerance. A quadratic programming solver is used to solve the optimization problem. A solution to this multi-objective optimization (MOO) problem returns weights for two objectives: value and cost. (In practice, only one weight needs to be returned: a weight that captures the relative weight of cost compared to value; however, referring to two weights helps to explain the score better.) With these weights, a score is computed for each eligible/candidate campaign (e.g., whose targeting criteria are satisfied). The weights are computed once and remain the same for all campaigns. The score may be calculated as follows:

score(campaign i)=w₁*E[value from showing campaign i]−w₂*E[cost of showing campaign i]=w₁*value(campaign i)*P_{click}(campaign i)−w₂*E_{cost}(campaign i)

E_{cost} may be determined as described above, such as through a fixed cost model where (1) a random bucket is used to display a random promotion, (2) a random control bucket is used where no promotion is displayed, and (3) a different in performance of the two buckets is determined and used to compute a cost of a promotion. An alternative approach to determining E_{cost} is using the machine-learned model approach described above.

The training data for the MOO problem is as follows: forecast the campaign impression opportunities for the next time period (e.g., a week or a month). Then, for each impression opportunity, obtain the list of eligible campaigns (based on targeting). Then, for each eligible campaign, predict the probability of click and the expected cost and prepare the following data:

Impression opportunity x:
Eligible campaign y:
   value(campaign y), Pchck(campaign y)

Ecost (campaign y)

In the above score equation, the same technique described previously for training a model to predict a P_{click} value may be used.

In an embodiment, a score is computed for a mock or fake “no-promo” campaign. Thus, if the mock campaign has a higher score than all other eligible campaigns, then no promotion is shown. The value of a fake “no-promo” may be 0, the probability of selecting a fake “no-promo” may be 0, and the cost of a fake “no-promo” may be 0 or a negative value. Thus, a fake “no-promo” promotion may be established as a fixed value (e.g., 0). This fixed value may be used as a threshold such that, if no computed score of an eligible campaign is greater than the threshold, then no campaign will be selected as part of a content item selection event.

### Example Process for the Per-Campaign Value-Based Approach

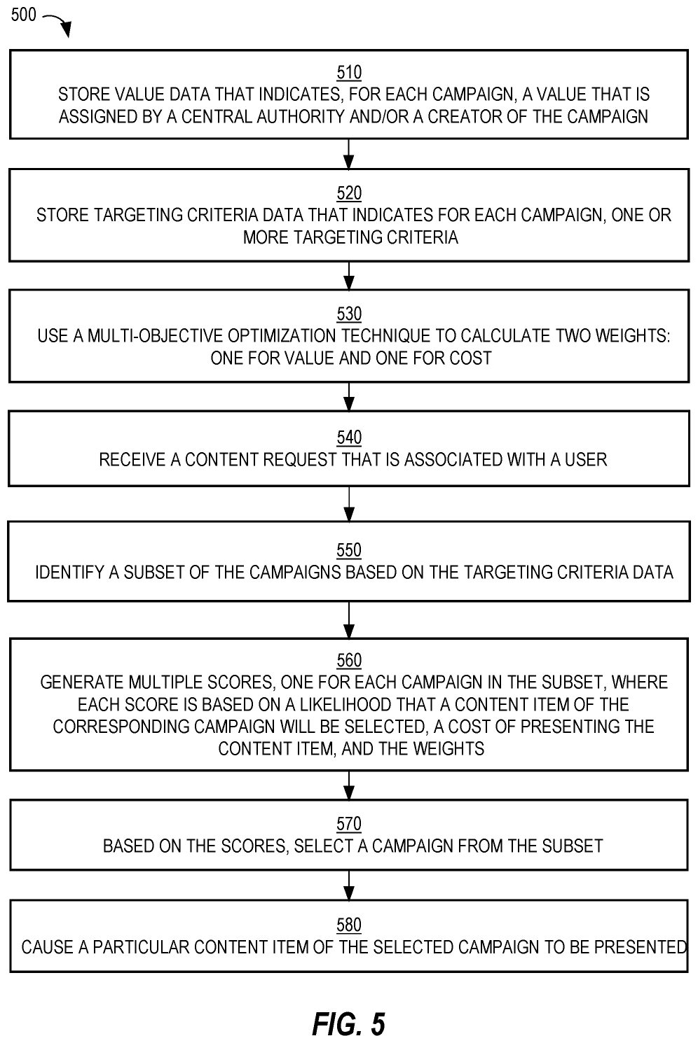

FIG. 5 is a flow diagram that depicts a process 500 for selecting a campaign according to the per-campaign value-based approach, in an embodiment.

At block 510, value data is stored that indicates, for each campaign of multiple campaigns, a value that is assigned by a central authority and/or by a creator of the campaign.

At block 520, targeting criteria data is stored that indicates, for each campaign, one or more targeting criteria that is assigned or established by a different entity, each of which is different than the central authority. However, the different entities are all associated with content delivery system 120. For example, the different entities may be different teams that are employed by the party that owns and/or operates content delivery system 120.

At block 530, a multi-objective optimization technique is used to calculate two weights, one for each of two objectives: value and cost.

At block 540, a content request is received. For example, publisher system 130 receives a content request from client device 144. As another example, content delivery system 120 receives a content request from client device 144 or from publisher system 130. If the latter, then the content request is triggered or initiated by a request from a client device, such as client device 144.

At block 550, a subset of the campaigns is identified based on the targeting criteria data. For example, a user identifier is determined based on the content request and one or more campaigns that target that user are identified (e.g., as having the user identifier listed in association with the campaigns). Additional attributes associated with the content request (e.g., attributes of the client device, attributes of a current geographic location, attributes of the time of day, attributes of the time of week) may be further used to filter that initial subset of campaigns.

At block 560, multiple scores for the campaigns in the subset are generated, where each score is based on a likelihood that a content item of the corresponding campaign will be selected, a cost of the corresponding campaign, and a weight (determined in block 530) for each of the two objectives. Block 560 may also involve scoring a mock or fake “no-promo” campaign.

At block 570, based on the scores, a particular campaign from the subset is selected.

At block 580, a content item of the particular campaign is caused to be displayed. Block 580 may involve content delivery system 120 transmitting a message that includes the content item (or a reference to the content item) over a computer network to a client device, such as client device 144.

An advantage of the per-campaign value-based approach is that the number of impressions of a high value campaign is not constrained by a resource allocation under the per-campaign resource limit approach. Also, under the per-campaign resource limit approach, it is not clear whether to deduct the value of a selected campaign or the cost of the selected campaign when a promotion of the selected campaign is presented.

Another advantage of the per-campaign value-based approach is that a variation of this approach (that involves a mock campaign) indicates whether to show a promotion at all for a content request (e.g., page view).

Also, specifying a cost tolerance constraint is relatively straightforward. A “control” bucket is run where no promotion is presented. This bucket is compared with a “random” bucket where random promotions are shown. The comparison indicates a loss in engagement and/or revenue on a page due to displaying random promotions. The cost tolerance may be established as a fraction of this loss. Also, the cost tolerance may be set for each page (or page type) of multiple pages (or page types).

Another advantage is that handling multi-dimensional cost is relatively easy; one constraint per dimension would be needed, such as click loss <T_{c} and revenue loss <Tᵣ.

Another advantage is that adding a new campaign is relatively straightforward. There is no need to adjust the cost tolerance constraint.

A disadvantage of the per-campaign value-based approach is that a low value promotion might never be selected and, therefore, presented. Also, computing the value of each promotion in a currency that is consistent across all campaigns is difficult because the objective of one campaign (e.g., brand affinity) may be very different than the objective of another campaign (e.g., profile edits). If different campaigns have different types of objectives, then a process for combining the different objectives to obtain a scalar value (e.g., representing revenue or engagement) would need to be devised.

### Global Constrained Optimization Approach

In an embodiment, a global constrained optimization approach is used to select a campaign from a set of eligible campaigns. In this approach, multi-objective optimization is performed over the campaign objectives of multiple (e.g., all) campaigns along with a cost objective. One of the campaign objectives would be considered the primary objective and global constraints (not per campaign) are set on the remaining objectives by, for example, a central authority. For example:

maximize profile edits

s.t.

brand affinity >target1

revenue >target2

application installs >target3

cost <tolerance

In this example, profile edits is the primary objective and the remaining entries of this multi-objective optimization problem are the constraints. Other example objectives include feed contributions and submissions of requests for proposals.

A constraint (e.g., brand affinity >target1) comprises an objective-target pair. A central authority may establish (or set) a cost tolerance and a target for each constraint. Alternatively, campaign creators may establish (or set) a target of a constraint.

In some situations, multiple campaigns have the same objective, such as application installs. This may be handled in one of two ways. There may be (a) a different constraint (and, thus, a different target) for each campaign having the same objective or (b) a single constraint for multiple campaigns having the same objective, thus having a single target.

A solution to the above multi-objective optimization problem comprises weights w₁, w₂, w₃, w₄, and w₅ for five objectives: profile edits, brand affinity, revenue, app installs, and cost respectively. Then, when a content request is received that triggers a content item selection event, one or more eligible or candidate campaigns are identified (based on the respective targeting criteria) and a score is computed for each eligible campaign as follows:

score(campaign i)=w₁*P_{profile_edit}(campaign i)+w₂*E_{brand_affinity}(campaign i)+w₃*Eᵣₑᵥₑₙᵤₑ(campaign i)+w₄*P_{app_install}(campaign i)−w₄*E_{cost}(campaign i)

The value of a P function is a probability and is a value between 0 and 1, while the value of an E function is value that is not bounded by 0 and 1.

In an embodiment, each P and E function is a machine-learned function that takes, as input, member features, campaign features, and context features and outputs an estimate for the corresponding metric.

In an embodiment, each P and E function is page specific as each of these functions takes context features as input. Different campaigns have different probabilities/expected values on different pages. However, MOO does not need to be run on each page type if the constraints are defined at a global level. If one or more constraints are defined per page, then multiple MOOs are run.

Given the above score equation, if a campaign's objective is a profile edit, then the only non-zero terms would be w₁*P_{profile_edit}(campaign i) and w₄*E_{cost}(campaign i). Similarly, if a campaign's objective is application installs, then the only non-zero terms would be w₄*P_{app_install}(campaign i) and w₄*E_{cost}(campaign i). However, in an embodiment, a campaign has multiple objectives, such as revenue and brand affinity. Thus, the score equation would have three or more non-zero terms.

In an embodiment, a score is determined (e.g., computed) for a mock or fake “no-promo” campaign. If the score of a mock campaign is higher than every other score (for every eligible campaign) computed during a content item selection event, then no campaign is selected and, consequently, no promotion is shown in response to the corresponding content request.

### Example Process for the Global Constraind Optimization Approach

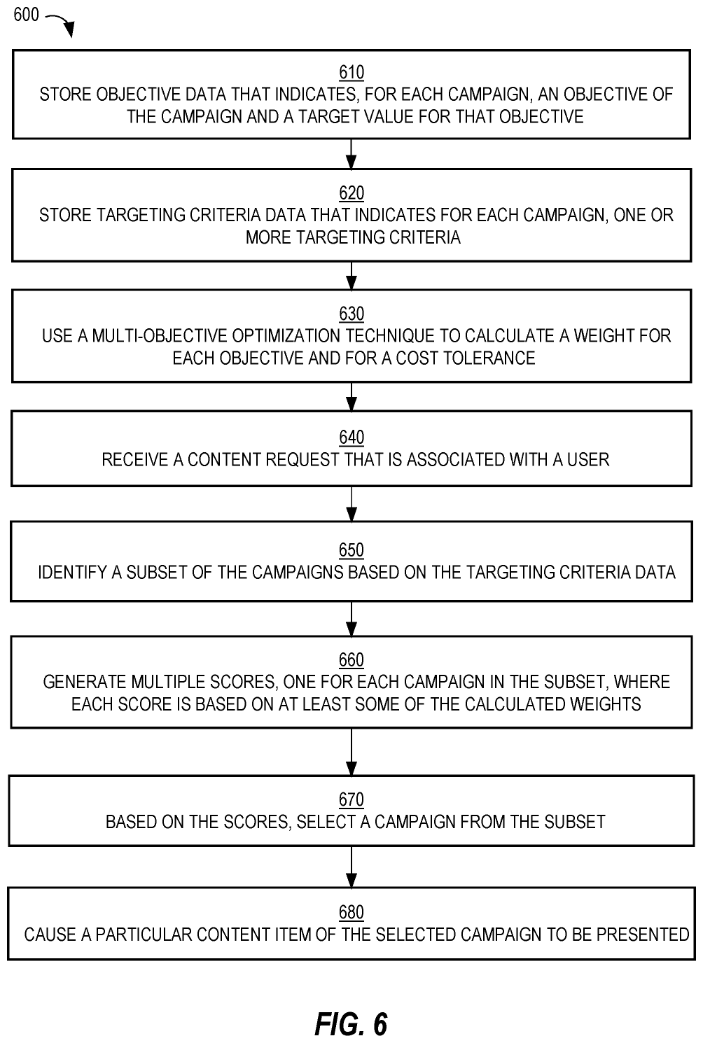

FIG. 6 is a flow diagram that depicts a process 600 for selecting a campaign according to the global constrained optimization approach, in an embodiment.

At block 610, objective data is stored that indicates, for each campaign of multiple campaigns, an objective of the campaign and a target value for that objective. The objective and target value may be assigned by a central authority and/or by a creator of the campaign.

At block 620, targeting criteria data is stored that indicates, for each campaign, one or more targeting criteria that is assigned or established by a different entity, each of which is different than the central authority. However, the different entities are all associated with content delivery system 120. For example, the different entities may be different teams that are employed by the party that owns and/or operates content delivery system 120.

At block 630, a multi-objective optimization technique is used to calculate multiple weights, one for each type of campaign objective and a cost tolerance. Thus, if there are five different types of campaign objectives and one cost tolerance, then six different weights are computed.

At block 640, a content request is received. For example, publisher system 130 receives a content request from client device 144. As another example, content delivery system 120 receives a content request from client device 144 or from publisher system 130. If the latter, then the content request is triggered or initiated by a request from a client device, such as client device 144.

At block 650, a subset of the campaigns is identified based on the targeting criteria data. For example, a user identifier is determined based on the content request and one or more campaigns that target that user are identified (e.g., as having the user identifier listed in association with the campaigns). Additional attributes associated with the content request (e.g., attributes of the client device, attributes of a current geographic location, attributes of the time of day, attributes of the time of week) may be further used to filter that initial subset of campaigns.

At block 660, multiple scores for the campaigns in the subset are generated, where each score is based on one or more campaign objectives, a cost tolerance, and weights (determined in block 630) for the campaign objective(s) and cost tolerance. Block 660 may also involve scoring a mock or fake “no-promo” campaign.

At block 670, based on the scores, a particular campaign from the subset is selected.

At block 680, a content item of the particular campaign is caused to be displayed. Block 580 may involve content delivery system 120 transmitting a message that includes the content item (or a reference to the content item) over a computer network to a client device, such as client device 144.

An advantage of this global constrained optimization approach is that, if the constraints are set correctly, then there is a guarantee that all objectives will be achieved. Another advantage of this approach is that a solution to the optimization problems informs content delivery system 120 whether to select a promotion campaign at all for each page view.

A disadvantage of this approach is that if there are two campaigns with the same objective and the first campaign always scores higher than the second campaign, then there is no way for the second campaign to be boosted, unless performed manually later when it is detected that the second campaign is not being selected during many content item selection events. Another disadvantage is that setting accurate constraints may be non-trivial and, therefore, difficult. Also, adding a new campaign is not trivial. A target of a constraint of the new campaign would need to be increased in order to serve the promotion of the campaign effectively.

### Improvement to Computer-Related Technology

Embodiments described herein reflect an improvement in computer-related technology. Embodiments leverage machine-learning techniques and past performance measures of web content in a new way to identify relevant electronic content while reducing loss in online engagement. All embodiments represent a technical solution to the technical problem of selecting which additional content item to present in response to a content request. Some embodiments track page-specific features and performance measures in order to determine which relevant content to select from among a set of potential content options.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

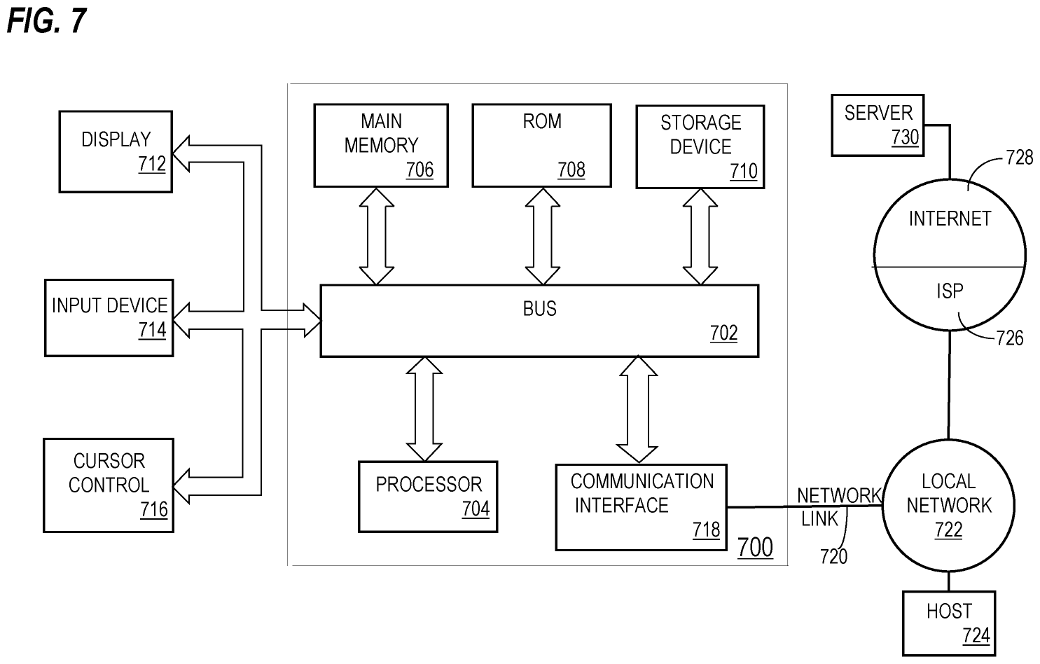

For example, FIG. 7 is a block diagram that illustrates a computer system 700 upon which an embodiment of the invention may be implemented. Computer system 700 includes a bus 702 or other communication mechanism for communicating information, and a hardware processor 704 coupled with bus 702 for processing information. Hardware processor 704 may be, for example, a general purpose microprocessor.

Computer system 700 also includes a main memory 706, such as a random access memory (RAM) or other dynamic storage device, coupled to bus 702 for storing information and instructions to be executed by processor 704. Main memory 706 also may be used for storing temporary variables or other intermediate information during execution of instructions to be executed by processor 704. Such instructions, when stored in non-transitory storage media accessible to processor 704, render computer system 700 into a special-purpose machine that is customized to perform the operations specified in the instructions.

Computer system 700 further includes a read only memory (ROM) 708 or other static storage device coupled to bus 702 for storing static information and instructions for processor 704. A storage device 710, such as a magnetic disk, optical disk, or solid-state drive is provided and coupled to bus 702 for storing information and instructions.

Computer system 700 may be coupled via bus 702 to a display 712, such as a cathode ray tube (CRT), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane.

Computer system 700 may implement the techniques described herein using customized hard-wired logic, one or more ASICs or FPGAs, firmware and/or program logic which in combination with the computer system causes or programs computer system 700 to be a special-purpose machine. According to one embodiment, the techniques herein are performed by computer system 700 in response to processor 704 executing one or more sequences of one or more instructions contained in main memory 706. Such instructions may be read into main memory 706 from another storage medium, such as storage device 710. Execution of the sequences of instructions contained in main memory 706 causes processor 704 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 710. Volatile media includes dynamic memory, such as main memory 706. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 702. Transmission media can also take the form of acoustic or light waves, such as those generated during radio-wave and infra-red data communications.

Various forms of media may be involved in carrying one or more sequences of one or more instructions to processor 704 for execution. For example, the instructions may initially be carried on a magnetic disk or solid-state drive of a remote computer. The remote computer can load the instructions into its dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal and appropriate circuitry can place the data on bus 702. Bus 702 carries the data to main memory 706, from which processor 704 retrieves and executes the instructions. The instructions received by main memory 706 may optionally be stored on storage device 710 either before or after execution by processor 704.

Computer system 700 also includes a communication interface 718 coupled to bus 702. Communication interface 718 provides a two-way data communication coupling to a network link 720 that is connected to a local network 722. For example, communication interface 718 may be an integrated services digital network (ISDN) card, cable modem, satellite modem, or a modem to provide a data communication connection to a corresponding type of telephone line. As another example, communication interface 718 may be a local area network (LAN) card to provide a data communication connection to a compatible LAN. Wireless links may also be implemented. In any such implementation, communication interface 718 sends and receives electrical, electromagnetic or optical signals that carry digital data streams representing various types of information.

Network link 720 typically provides data communication through one or more networks to other data devices. For example, network link 720 may provide a connection through local network 722 to a host computer 724 or to data equipment operated by an Internet Service Provider (ISP) 726. ISP 726 in turn provides data communication services through the world wide packet data communication network now commonly referred to as the “Internet” 728. Local network 722 and Internet 728 both use electrical, electromagnetic or optical signals that carry digital data streams. The signals through the various networks and the signals on network link 720 and through communication interface 718, which carry the digital data to and from computer system 700, are example forms of transmission media.

Computer system 700 can send messages and receive data, including program code, through the network(s), network link 720 and communication interface 718. In the Internet example, a server 730 might transmit a requested code for an application program through Internet 728, ISP 726, local network 722 and communication interface 718.

The received code may be executed by processor 704 as it is received, and/or stored in storage device 710, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
storing resource allocation data that indicates, for each campaign of a plurality of campaigns, a resource allocation amount that is assigned by a central authority;
storing targeting criteria data that indicates, for each campaign of the plurality of campaigns, one or more targeting criteria that is assigned by a different entity of a plurality of entities, each of which is different than the central authority;
receiving a content request;
in response to receiving the content request:
identifying a subset of the plurality of campaigns based on the targeting criteria data;
generating a plurality of scores for the campaigns in the subset, wherein each score in the plurality of scores reflects a likelihood that a content item of the corresponding campaign will be selected;
based on a plurality of scores, selecting a particular campaign from the subset;
causing a particular content item of the particular campaign to be displayed;
identifying a particular resource allocation amount that is associated with the particular campaign;
determining a resource reduction amount associated with displaying the particular content item of the particular campaign;
reducing the particular resource allocation based on the resource reduction amount;
wherein the method is performed by one or more computing devices.

2. The method of claim 1, further comprising:
determining a first type of page on which the particular content item is displayed;
wherein determining the resource reduction amount is based on the first type of page.

3. The method of claim 1, wherein the resource reduction amount is a first reduction amount, wherein determining the first reduction amount is based on the particular campaign, the method further comprising:
in response to receiving a second content request:
identifying a second subset of the plurality of campaigns based on the targeting criteria data;
generating a second plurality of scores for the campaigns in the second subset, wherein each score in the second plurality of scores reflects a likelihood that a content item of the corresponding campaign will be selected;
based on a second plurality of scores, selecting, from the second subset, a second campaign that is different than the particular campaign;
causing a second content item of the second campaign to be displayed;
identifying a second resource allocation amount that is associated with the second campaign;
determining, based on the second campaign, a second reduction amount associated with displaying the second content item of the second campaign, wherein the second reduction amount is different than the first reduction amount;
reducing the second resource allocation based on the second reduction amount.

4. A method comprising:
storing value data that indicates, for each campaign of a plurality of campaigns, a value that is assigned to said each campaign;
storing targeting criteria data that indicates, for each campaign of the plurality of campaigns, one or more targeting criteria;
applying a multi-objective optimization technique to calculate a first weight for value and a second weight for cost;
calculating a plurality of costs, wherein each cost of the plurality of costs indicates, for each campaign of the plurality of campaigns, a cost of presenting a content item of said each campaign;
receiving a content request;
in response to receiving the content request:
identifying a subset of the plurality of campaigns based on the targeting criteria data;
generating a plurality of scores for the campaigns in the subset, wherein each score in the plurality of scores corresponds to a different campaign in the subset and is based on the value data, a cost of the plurality of costs, the first weight, and the second weight;
based on a plurality of scores, selecting a particular campaign from the subset;
causing a particular content item of the particular campaign to be displayed;
wherein the method is performed by one or more computing devices.

5. The method of claim 4, wherein:
the value data indicates a first value for a first campaign of the plurality of campaigns;
the value data indicates, for a second campaign of the plurality of campaigns, a second value that is different than the first value.

6. The method of claim 4, further comprising:
determining whether each score of the plurality of scores is greater than a particular threshold;
selecting the particular campaign only in response to determining that the particular threshold is not greater than all of the plurality of scores.

7. The method of claim 4, further comprising:
determining a first performance of one or more pages when a content item of a campaign of the plurality of campaigns is presented;
determining a second performance of the one or more pages when no content item of any campaign of the plurality of campaigns is presented;
wherein the second weight for cost is based on a difference between the first performance and the second performance.

8. The method of claim 4, wherein calculating the plurality of costs comprises, for each campaign of the plurality of campaigns:
determining a first performance of one or more pages when a content item of said each campaign is presented;
determining a second performance of the one or more pages when no content item of any campaign of the plurality of campaigns is presented;
wherein a cost, of the plurality of costs, for said each campaign is based on a difference between the first performance and the second performance.

9. The method of claim 4, further comprising:
after the plurality of campaigns are active for a period of time, creating a new campaign;
updating the value data to indicate a particular value for the new campaign;
updating the targeting criteria data based on target criteria associated with the new campaign;
in response to a second content request:
identifying, based on the targeting criteria data, a set of campaigns that includes the new campaign;
generating a second plurality of scores for the campaigns in the set, wherein each score in the second plurality of scores corresponds to a different campaign in the set and is based on the value data, a cost of the second plurality of costs, the first weight, and the second weight;
based on a second plurality of scores, selecting a second campaign from the set;
causing a content item of the second campaign to be displayed.

10. A method comprising:
storing targeting criteria data that indicates, for each campaign of the plurality of campaigns, one or more targeting criteria;
wherein each campaign corresponds to an objective of a plurality of objectives;
applying a multi-objective optimization technique to calculate a plurality of weights, wherein each weight of the plurality of weights corresponds to a different objective of the plurality of objectives;
calculating a plurality of costs, wherein each cost of the plurality of costs indicates, for each campaign of the plurality of campaigns, a cost of presenting a content item of said each campaign;
receiving a content request;
in response to receiving the content request:
identifying a subset of the plurality of campaigns based on the targeting criteria data;
generating a plurality of scores for the campaigns in the subset, wherein each score in the plurality of scores corresponds to a different campaign in the subset and is based on a subset of the plurality of weights and a cost of the plurality of costs;
based on a plurality of scores, selecting a particular campaign from the subset;
causing a particular content item of the particular campaign to be displayed;
wherein the method is performed by one or more computing devices.

11. The method of claim 10, wherein the plurality of objectives include one or more of profile edits, application installs, feed contributions, or request for proposals.

12. The method of claim 10, further comprising:
determining whether each score of the plurality of scores is greater than a particular threshold;
selecting the particular campaign only in response to determining that the particular threshold is not greater than all of the plurality of scores.

13. The method of claim 10, wherein calculating the plurality of costs comprises, for each campaign of the plurality of campaigns:
determining a first performance of one or more pages when a content item of said each campaign is presented;
determining a second performance of the one or more pages when no content item of any campaign of the plurality of campaigns is presented;
wherein a cost, of the plurality of costs, for said each campaign is based on a difference between the first performance and the second performance.

14. The method of claim 10, wherein:
the subset of the plurality of campaigns includes a first campaign that is associated with a first objective;
the subset of the plurality of campaigns includes a second campaign that is associated with a second objective that is different than the first objective;
generating the plurality of scores comprises:
generating a first score for the first campaign based on a first weight that is associated with the first objective and a first cost of the plurality of costs;
generating a second score for the second campaign based on a second weight that is associated with the second objective and a second cost of the plurality of costs.
